(19) United States
(12) Patent Application Publication
(10) Pub. No.: US 2012/0218524 A1
(43) Pub. Date: Aug. 30, 2012

(54) PROJECTOR AND METHOD FOR CORRECTING KEYSTONE DISTORTION

(75) Inventors: PING-YANG CHUANG, Tu-Cheng (TW); YING-CHUAN YU, Tu-Cheng (TW); HSING-CHU WU, Tu-Cheng (TW)

(73) Assignee: HON HAI PRECISION INDUSTRY CO., LTD., Tu-Cheng (TW)

(21) Appl. No.: 13/193,591

(22) Filed: Jul. 28, 2011

(30) Foreign Application Priority Data
Feb. 24, 2011 (TW) 100106122

(51) Int. Cl. G03B 21/14

(52) U.S. Cl. 353/70; 353/121

(57) ABSTRACT

A method for correcting keystone distortion is provided. The method is applied on a projector capable of correcting keystone distortion. The apparatus includes an angle detecting unit and a storage unit. The angle detecting unit detects an inclined angle and outputs a voltage value corresponding to the detected inclined angle. The storage unit stores a relationship between the inclined angles and the voltage values. The method includes determining the inclining angle according to the voltage value and the stored relationship; calculating the ratio of the length of the upper side of the projection area of a source image projected onto a projection surface to the length of the lower side of the projection area of a source image projected onto the projection surface, and inversing the ratio to determine a correction coefficient; and modifying the source image to display the source image onto the projection surface.

### BACKGROUND

1. Technical Field

The present disclosure relates to projectors and, particularly, to a projector capable of correcting keystone distortion and a method for correcting keystone distortion.

2. Description of Related Art

When using a projector, the projector is placed on a support surface such as a desk to project images onto a projection surface such as a wall. To ensure that the projected images are not distorted, the projector needs to be placed perpendicular to the support surface to make sure the optical axis of the projector is perpendicular to the projection surface. This need of placing the projector in proper position when in use may be difficult to achieve in some cases.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a projector capable of correcting keystone distortion in accordance with an exemplary embodiment.

FIG. 2 is a diagram showing relationship between detected angles and output voltage values.

FIG. 3 is a schematic view showing the projector of FIG. 1 projecting source images on a projection surface in a first embodiment.

FIG. 4 is a principle view showing how to determine the correcting coefficient of the projector of the FIG. 1 in the first embodiment.

FIG. 5 is a schematic view showing the projector of FIG. 1 projecting source images on the projection surface in a second embodiment.

FIG. 6 is a principle view showing how to determine a correcting coefficient of the projector of the FIG. 1 in the second embodiment.

FIG. 7 is a flowchart of a method for correcting keystone distortion in accordance with an exemplary embodiment.

### DETAILED DESCRIPTION

Embodiments of the present disclosure are now described in detail, with reference to the accompanying drawings.

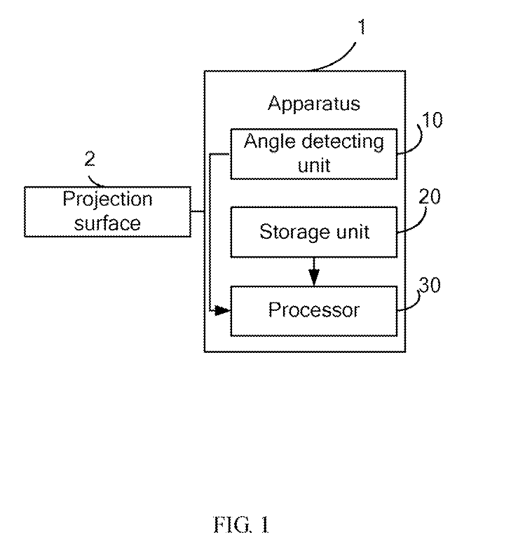

Referring to FIG. 1, a block diagram of a projector 1 capable of correcting keystone distortion in accordance with an exemplary embodiment is shown. The projector 1 can project images onto a projection surface 2. In this embodiment, the projector 1 modifies a source image before projecting the source image onto the projection surface 2 to project the source image without distortion. The projector 1 includes an angle detecting unit 10, a storage unit 20, and a processor 30.

The angle detecting unit 10 is to detect an inclined angle of the projector 1 and output a voltage value corresponding to the detected inclined angle. In the embodiment, the angle detecting unit 10 is a G-sensor 10. When the detected inclined angle increases or decreases the voltage value output by the G-sensor 10 increases or decreases. In the embodiment, the detected angle is from −90° to 90°, and the voltage value is from 1.3V to 3.7V.

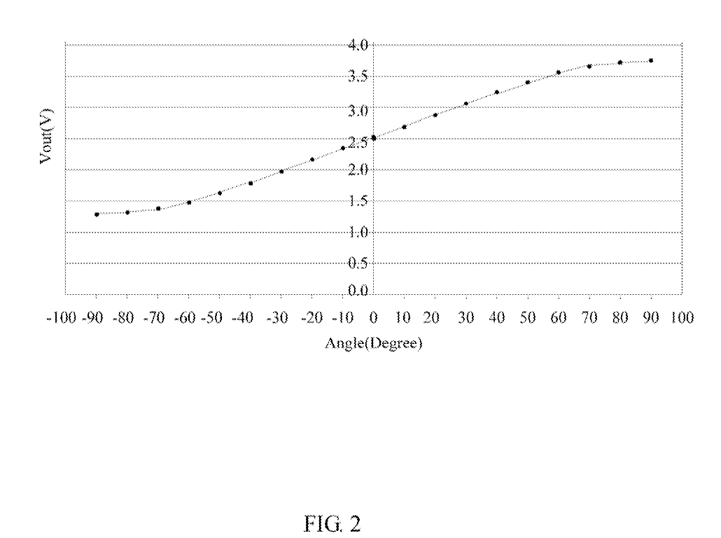

Referring to FIG. 2, the storage unit 20 stores a relationship between the detected angles and the voltage values output by the G-sensor 10.

The processor 30 is electrically connected to the angle detecting unit 10. The processor 30 obtains the voltage value output by the G-sensor 10, and determines the inclined angle of the projector 1 according to the obtained voltage value and the stored relationship. Each source image includes an upper side and a lower side. The processor 30 calculates the ratio of the length of the upper side to the length of the lower side, inverses the ratio to determine a correction coefficient, and modifies the source image according to the correction coefficient to project the source image onto the projection surface 2 without distortion. The detail method of determining the correction coefficient will be described below.

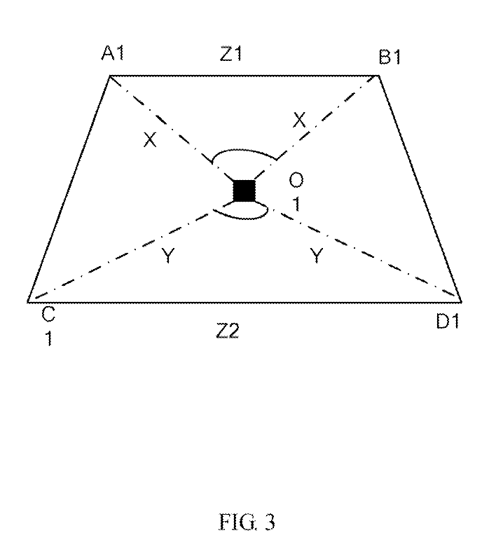

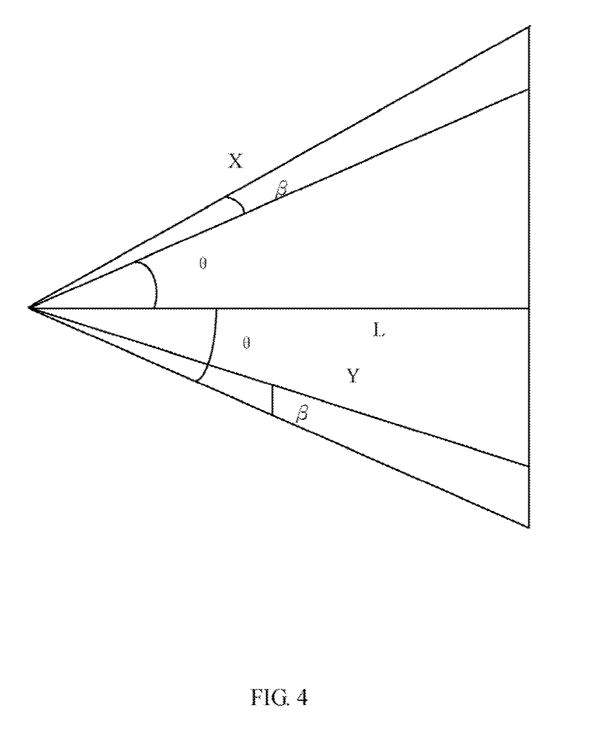

FIGS. 3-4 are schematic views showing how to determine the correction coefficient of the projector 1 when the projector 1 does not have an offset lens. When the projector 1 does not have an offset lens, the projection area projected on the projection surface 2 by the projector 1 starts at the bottom of the lens. The projection area includes four vertexes A1, B1, C1, and D1. The position of the projector 1 is O1. The upper vertexes A1 and B1 and the projector 1 form two sides O1A1 and O1B1. The lower vertexes C1 and D1 and the projector 1 form two sides O1C1 and O1D1. The length of the side O1A1 is equal to that of the side O1B1, and the length of the side O1C1 is equal to that of the side O1D1. As the angle formed by the two sides O1A1 and O1B1 is equal to that formed by the two sides O1C1 and O1D1, the ratio of the length of the upper side Z1 to the length of the lower side Z2 is equal to that of the side O1A1 or O1B1 X to O1C1 or O1D1 Y. For example, if the angle of projection of the projector 1 is 2θ, the distance between the projector 1 and the projection surface 2 is L, and the inclined angle detected by the angle detecting unit 10 is β, thus X=L/cos(θ+β), Y=L/cos(θ−β), and Z1/Z2=Y/X=(L/cos(θ−β))/(L/cos(θ+β))=cos(θ+β)/cos(θ−β).

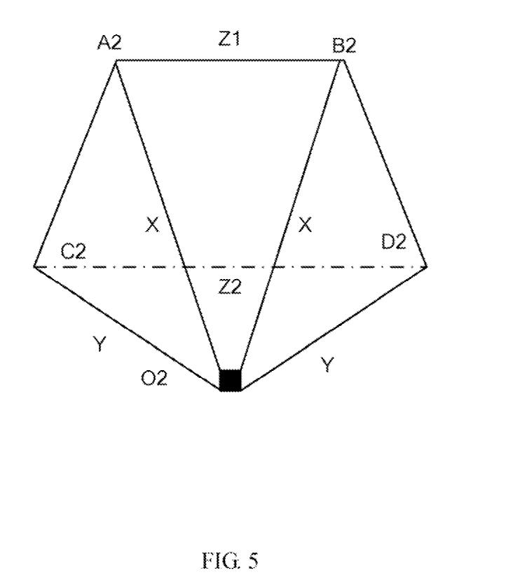

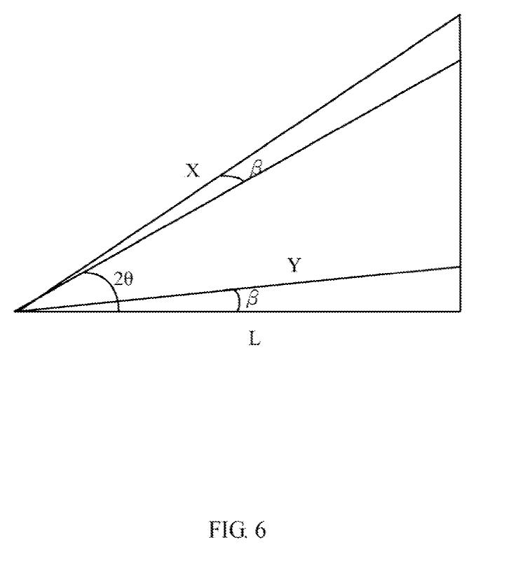

FIGS. 5-6 are schematic views showing how to determine the calculation correction coefficient of the projector 1 when the projector has an offset lens. When the projector 1 has an offset lens, the projection area projected on the projection surface 2 by the projector 1 starts at the center of the lens. The projection area includes four vertexes A2, B2, C2, and D2. The position of the projector 1 is O2. The upper vertexes A2 and B2 and the projector 1 form two sides O2A2 and O2B2. The lower vertexes C2 and D2 and the projector 1 form two sides O2C2 and O2D2. The length of the side O2A2 is equal to that of O2B2, and the length of the side O2C2 is equal to that of O2D2. As the angle formed by the two sides O2A2 and O2B2 is equal to that formed by the two sides O2C2 and O2D2, the ratio of the length of the upper side Z1 to the length of the lower side Z2 is equal to that of the side O2A2 X or O2B2 X to O2C2 Y or O2D2 Y. For example, if the angle of projection of the projector 1 is 2θ, the distance between the projector 1 and the projection surface 2 is L, and the inclined angle detected by the angle detecting unit 10 is β, thus X=L/cos(2θ+β), Y=L/cosβ, and Z1/Z2=Y/X=(L/cosβ)/(L/cos(2θ+β))=cos(2θ+β)/cosβ.

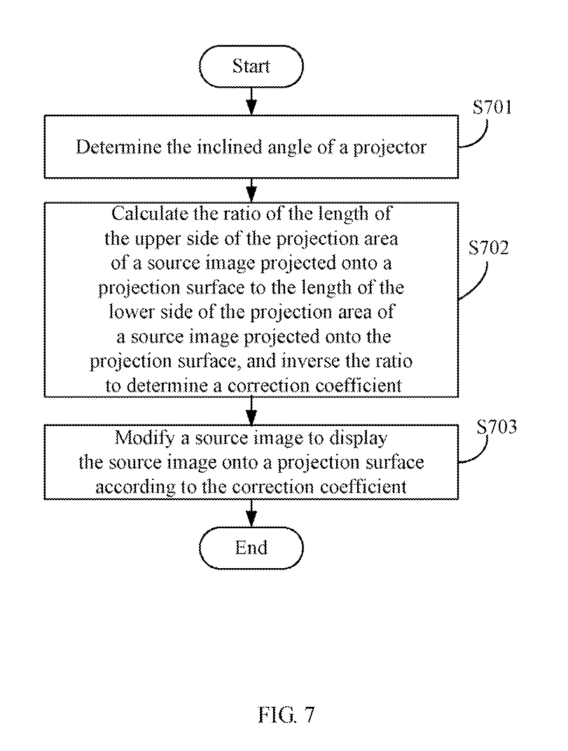

Referring to FIG. 7, a method for correcting keystone distortion in accordance with an exemplary embodiment.

In step S701, the processor 30 obtains the voltage value output by the angle detecting unit 10, and determines the inclined angle of the projector 1 according to the voltage value and the stored relationship.

In step S702, the processor 30 calculates the ratio of the length of the upper side to the length of the lower side, and inverses the ratio to determine a correction coefficient.

In step S703, the processor 30 modifies the source image according to the correction coefficient to project the source image onto the projection surface 2 without distortion.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A projector capable of correcting keystone distortion, comprising:
an angle detecting unit to detect an inclined angle of the projector and output a voltage value according to the detected inclined angle;
a storage unit storing a relationship between the inclined angles and the voltage values; and
a processor to obtain the voltage value output by the angle detecting unit, determine the inclined angle according to the output voltage value and the relationship stored in the storage unit, calculate the ratio of the length of the upper side of a projection area of a source image projected onto a projection surface to the length of the lower side of the projection area of a source image projected onto the projection surface, inverse the ratio to determine the correction coefficient, and further modify the source image to project the source image onto the projection surface according to the correction coefficient.

2. The projector as described in claim 1, wherein the angle detecting unit is a G-sensor.

3. The projector as described in claim 1, wherein projector has not an offset lens.

4. The projector as described in claim 1, wherein the projector has an offset lens.

5. A method for correcting keystone distortion, the method being applied on a projector capable of correcting keystone distortion, the projector comprising an angle detecting unit and a storage unit, the angle detecting unit being to detect an inclined angle of the projector and output a voltage value corresponding to the detected inclined angle, the storage unit storing a relationship between the inclined angles and the voltage value, wherein the method comprises:
obtaining the output voltage value from the angle detecting unit, and determining the inclined angle according to the obtained voltage value and the stored relationship;
calculating the ratio of the length of the upper side of the projection area of a source image projected onto a projection surface to the length of the lower side of the projection area of a source image projected onto the projection surface, and inversing the ratio to determine a correction coefficient; and
modifying the source image to display the source image onto the projection surface according to the determined correction coefficient.
